(19) United States
(12) Patent Application Publication
(10) Pub. No.: US 2008/0046750 A1
(43) Pub. Date: Feb. 21, 2008

(54) Authentication method

(75) Inventors: Scott Fletcher, Manchester (GB); Andrew Whitworth, Worcestershire (GB)

Correspondence Address: PILLSBURY WINTHROP SHAW PITTMAN LLP, P.O BOX 10500, McLean, VA, 22102, US

(73) Assignee: ASSOCIATED NETWORK SOLUTIONS PLC, Manchester Science Park (GB)

(21) Appl. No.: 11/506,631

(22) Filed: Aug. 18, 2006

(51) Int. Cl. H04L 9/00

(52) U.S. Cl. 713/185

(57) ABSTRACT

A computer implemented method of authenticating a user. Method comprises reading an identifier from a token, the token being in communication with a computer. An attempt is made to locate a record in a data store on the basis of the identifier, the record comprising authentication data. If the attempt is successful, authentication is performed using the located authentication data.

The present invention relates to an authentication method. More particularly, the invention relates to an authentication method using a token such as a smartcard.

Computers are now ubiquitous in modern society. Many organisations operate a network of computers which are connected together to allow users to share resources such as storage space and printing devices. For security reasons access to such networks is controlled using authentication methods.

Typically, when wanting to use a computer connected to a network, a user is asked to enter a username and password. The entered data is then compared with data stored in a database, and if but only if the comparison indicates that the input data matches the data in the database is a user allowed to access the network.

More recently, authentication methods using tokens such as smartcards have been used to control access to computer networks. In one such system a smartcard is provided with one or more certificates. When wishing to logon to a computer the user inserts the smartcard into an appropriate reader, and the computer to be used then prompts a user to enter a personal identification number (PIN). The PIN number is verified by a computer program code running on the smartcard, and if the verification is successful the user is then allowed to use the certificate as a means for authenticating himself or herself to the computer network. That is, the certificate is read from the card and transmitted to a remote server so that authentication can take place. It will be appreciated that the requirement that the user enters a PIN is important so as to restrict use of a particular smartcard to a particular user.

Token based authentication as described above offers various benefits over more traditional authentication using usernames and passwords given that users may divulge their usernames and passwords to others thereby allowing those others to logon to the network using false authentication data. It is clearly more difficult to share authentication data in this way using a token based authentication method, given that a physical token must be exchanged between the users.

Although token based authentication systems provide benefits such as those described above they do require that a certificate appropriate to a network to which it is desired to logon is stored on the smartcard. Thus, if a user wishes to log onto a plurality of networks a plurality of certificates would be required. Given that smartcards have limited storage capacity storage of multiple certificates may not be possible thereby requiring a user to carry more than one smartcard. Furthermore, it is necessary to register particular smartcards with particular networks using registration procedures which can typically be relatively complex.

It is an object of embodiments of the present invention to obviate or mitigate at least some of the problems set out above.

According to the present invention, there is provided, a computer-implemented method of authenticating a user. The method comprises reading an identifier from a token, said token being in communication with said computer, attempting to locate a record in a data store on the basis of said identifier, said record comprising authentication data, and if said attempting is successful, performing authentication using said located authentication data.

By reading data from the token and using said data to locate authentication data in a data store it will be appreciated that a token containing a single unique identifier can be used to authenticate a user on a plurality of different systems, each system requiring different authentication data.

The authentication data may comprise first and second data items, and the first data item may be a username, and said second data item may be a password. Records of said data store may store an identifier together with respective first and second data items. The authentication data may comprise data indicative of an authentication policy. For example, data indicative of the authentication policy may take the form of a bit mask and indicate data which a user is required to input to allow authentication to take place. The authentication data may comprise data indicating a domain in which the user is to be authenticated.

If said attempting is unsuccessful, the method may further comprise, requesting input data comprising authentication data, receiving input data comprising said authentication data, and performing authentication using said authentication data of said input data. If said attempting is unsuccessful, the method may further comprise creating a record in said data store associating said identifier with said input authentication data.

The input authentication data may comprise first and second input data items, the first input data item may be a username and the second input data item may be a password.

If the attempting is successful, the method may comprise receiving an object, said object comprising said identifier, and at least one field storing said authentication data. If the attempting is unsuccessful, the method may comprise receiving an object comprising said identifier, and at least one field storing a default value. The received object may comprise first and second fields, said first and second fields storing said authentication data if said attempting is successful and said first and second fields storing default values if said attempting is unsuccessful.

Determining whether said attempting is successful may comprise querying said at least one field. The attempting may be determined to be unsuccessful if said at least one field stores a default value and the attempting may be determined to be successful if said at least one field stores populated with authentication data.

Reading an identifier from said token may comprise reading an identifier from said token, prompting a user to input a verification data item associated with said token; and verifying said verification data item associated with said token. Verification may be carried out by the token.

Verifying the data item comprises providing said verification data item to the token together with a request for verification, and receiving data indicating whether said verification was successful from said token. The verification data item may be a personal identification number.

Authentication using said authentication data may be carried out by an authentication service provided by an operating system. The method may further comprise prompting the operating system to display a dialog; and providing said authentication data via said dialog.

The method may further comprise storing data recording data read from and data written to said data store. The data store may be an encrypted data store.

The method may comprise receiving data indicative of a change to said authentication data; and updating said data store in response to said change. Said change to said authentication data may comprise a change to said authentication data in an operating system data store. The authentication data may comprise a password and said change to said authentication data may comprises a change to said password.

The token may be a smartcard, more particularly a contact or contactless smartcard. Communication between said token and said computer may be wireless communication. Said communication may be Bluetooth communication.

The invention further provides a data carrier carrying computer readable instructions configured to cause a computer to carry out a method as set out above.

The invention also provides a computer apparatus for authenticating a user, the computer apparatus comprises a program memory containing processor readable instructions; and a processor configured to read and execute instructions stored in said program memory; wherein said processor readable instructions comprise instructions controlling the computer to carry out a method as set out above.

The invention still further provides a computer implemented method of authenticating a user, comprising: reading an identifier from a token, said token being in communication with said computer; requesting authentication data from a remote data store on the basis of said identifier; and if said requesting returns authentication data, performing authentication using said authentication data.

There is also provided a computer implemented method for authenticating a user, comprising: receiving an identifier from a remote computer, said identifier being read from a token which is in communication with said remote computer; and attempting to locate a record in a data store on the basis of said received identifier, said record comprising authentication; and transmitting data to said remote computer indicating whether said attempting is successful, wherein if said attempting is successful, said remote computer performs authentication using said located authentication data.

A further aspect of the present invention provides, a networked computer system comprising a terminal in communication with a server, wherein the terminal comprises means for reading an identifier from a token in communication with the terminal; and means for transmitting said identifier to said server, the server comprises means for receiving a transmitted identifier, means for attempting to locate a record in a data store on the basis of said identifier, and means for transmitting data to said at least one terminal indicating whether said attempting is successful, and the terminal comprises means for performing authentication using data located by said server.

Embodiments of the present invention will now be described, by way of example, with reference to the accompanying drawings, in which:

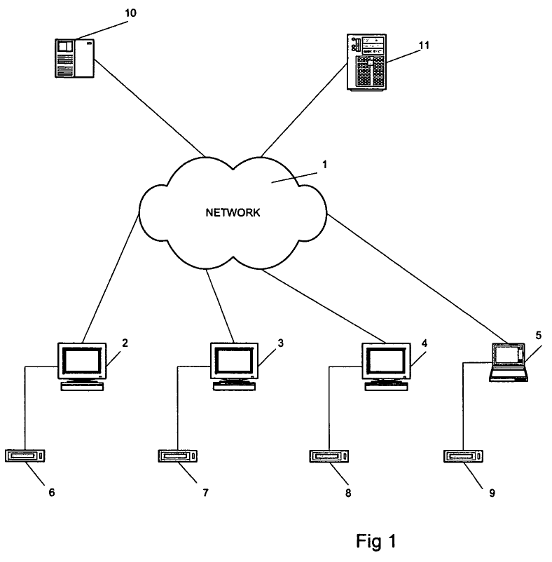

FIG. 1 is a schematic illustration of a computer network suitable for implementing the present invention;

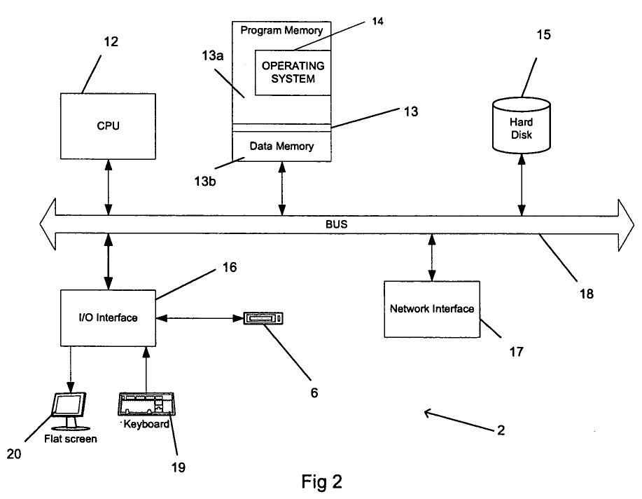

FIG. 2 is a schematic illustration of a desktop PC illustrated in FIG. 1;

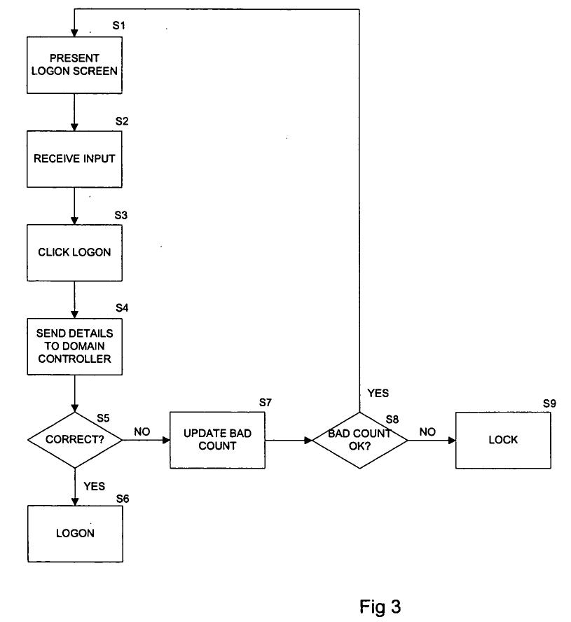

FIG. 3 is a flowchart of a known authentication process which can be used on the network of FIG. 1;

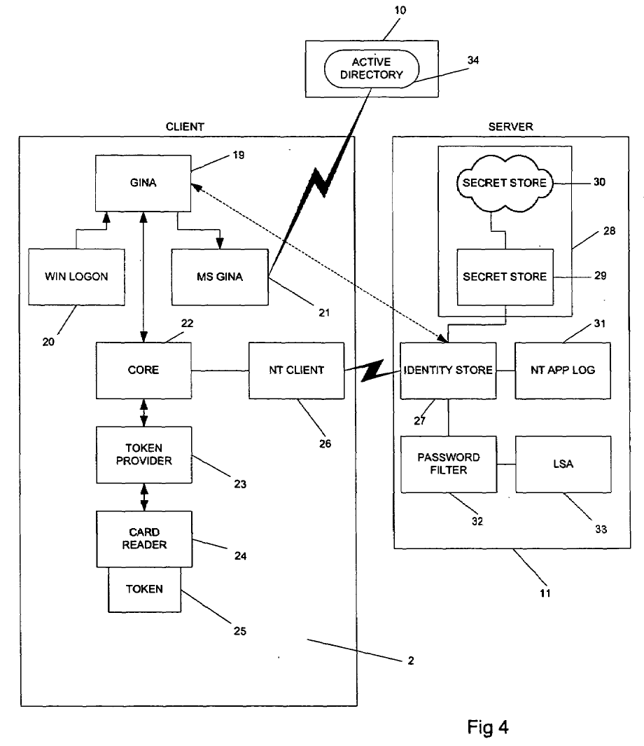

FIG. 4 is a schematic illustration of software components suitable for implementing an embodiment of the present invention;

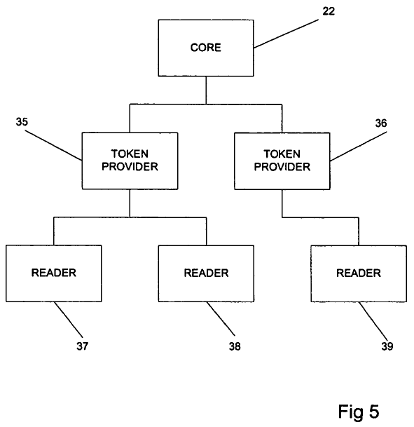

FIG. 5 is a schematic illustration of software components shown in FIG. 4 in further detail;

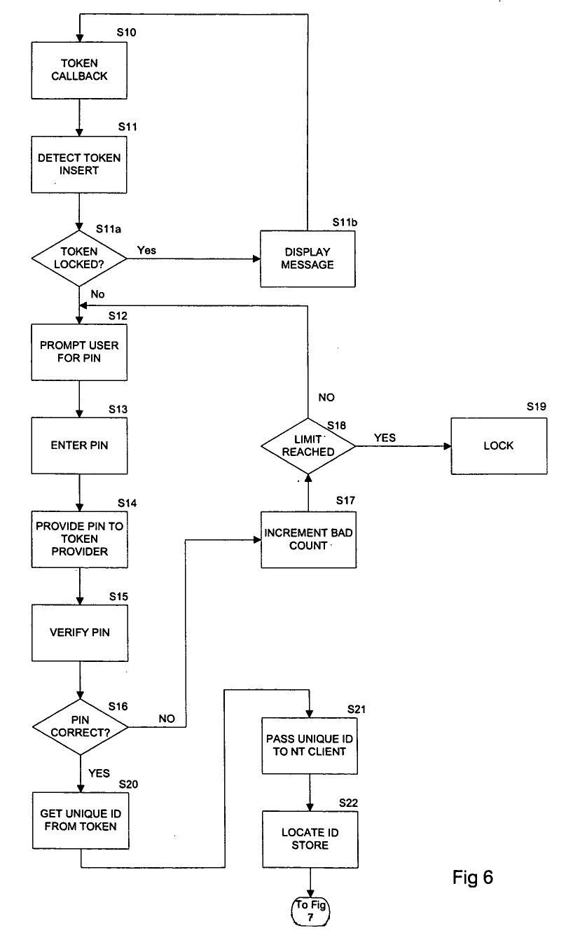

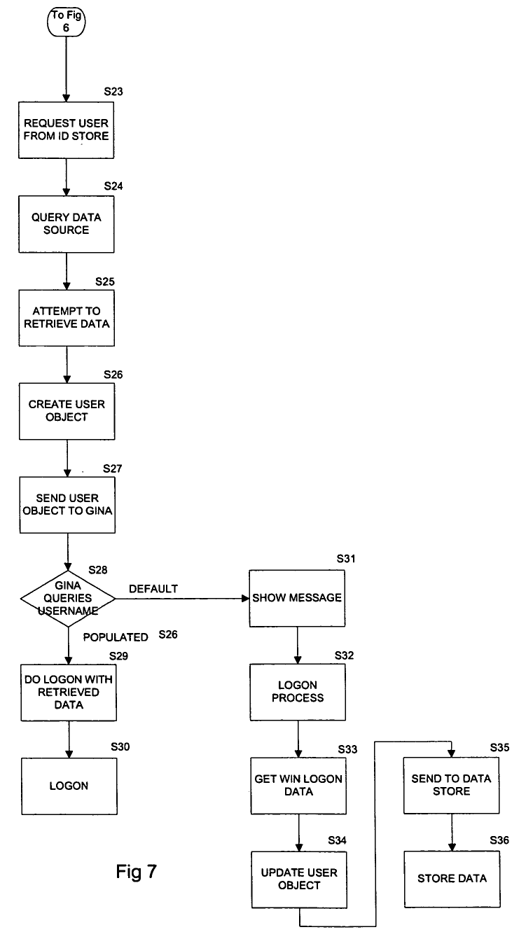

FIGS. 6 and 7 are flowcharts showing processing carried out in an embodiment of the present invention, using the software components shown in FIGS. 4 and 5;

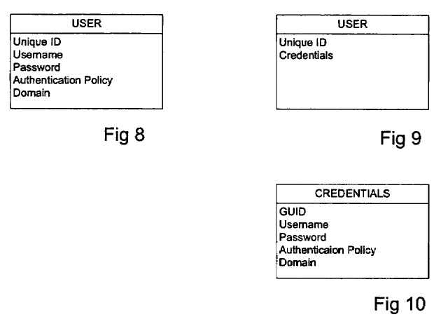

FIGS. 8 to 10 are illustrations of objects used in embodiments of the present invention;

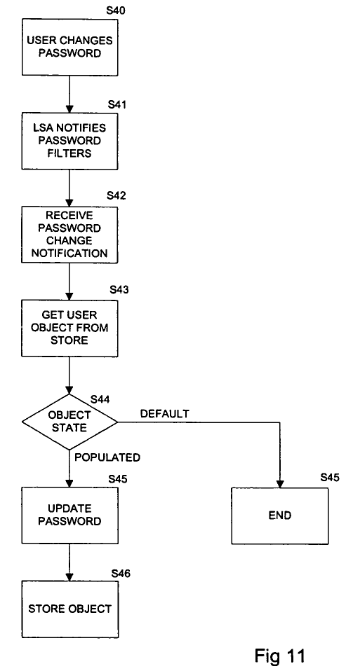

FIG. 11 is a flowchart of processing carried out when a password is changed in embodiments of the present invention; and

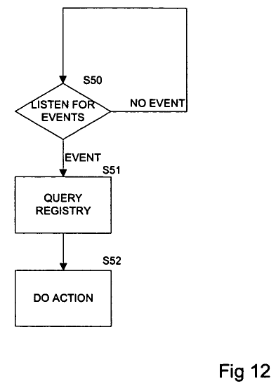

FIG. 12 is a flowchart of a process used in embodiments of the present invention to listen for events of interest;

FIG. 1 is a schematic illustration of a plurality of computers connected together by a computer network 1. The computers connected to the network 1 comprise three desktop PCs 2, 3, 4 and a laptop computer 5. Each of the desktop PCs 2, 3, 4 and the laptop computer 5 are connected to respective smart card readers 6, 7, 8, 9. The smart card readers 6, 7, 8, 9 can conveniently be connected to the respective computers by respective Universal Serial Bus (USB) connections.

In the illustration of FIG. 1, two servers 10, 11 are also connected to the network 1. These servers can, as is conventional, provide services to users of the desktop PCs 2, 3, 4 and the laptop computer 5. In the described embodiment, the server 10 acts as a domain controller. That is, the server 10 manages a user database and is responsible for authenticating users of the desktop PCs 2, 3, 4 and the laptop computer 5 to allow them to access resources provided by the network 1.

In a described embodiment, the network 1 is a wired local area network in which the desktop PCs 2, 3, 4, the laptop computer 5, and the servers 10, 11 are provided with suitable hardware to allow access to the network 1. It will however be appreciated that the network 1 can, in some embodiments of the invention, be a wireless network operating, for example, using a wireless local area network protocol such as IEEE 802.11.

FIG. 2 illustrates the desktop PC 2 in further detail. It will be understood that the desktop computers 3, 4 are of similar structure.

The desktop computer 2 comprises a central processing unit (CPU) 12 and random access memory (RAM) 13. The RAM 13 comprises a program memory 13a and a data memory 13b. During operation of the desktop PC 2, the program memory 13a stores operating system code 14 which is used to control operation of the desktop PC 2.

The desktop PC 2 further comprises a non volatile storage device in the form of a hard disk drive 15 and an input/output (I/O) interface 16. The desktop PC 2 further comprises a network interface 17 which is used to allow the desktop PC 2 to communicate with other computers via the network 1. The aforementioned components of the desktop PC 2 are connected together by a central communications bus 18 in a conventional manner.

It has been described above that the desktop PC 2 comprises an I/O interface 16 and it can be seen from FIG. 2 that a keyboard 19 and a flat screen monitor 20 are connected to the I/O interface. Similarly, the smart card reader 6 depicted in FIG. 1 is connected to the desktop PC 2 by the I/O interface 16.

It will be appreciated that the configuration illustrated in FIG. 2 is merely exemplary, and can be varied in a number of ways. Such variants will be well known to those of ordinary skill in the art.

Having described the architecture of the network 1 and the architecture of the desktop PC 2, FIG. 3 illustrates a process which a user of the desktop PC 2 may use to logon to the network 1. That is, a process which a user of the desktop PC 2 may use to authenticate their user details with a server 10 which acts as a domain controller. Such a process is well known in the art.

Referring to FIG. 3, at step S1 the operating system code 14 presents a logon screen to a user of the desktop PC 2. This logon screen will typically request from the user details of a username and password. Appropriate input data is input using, for example, the keyboard 19 and this is received by the operating system code 14 at step S2. When the data has been input into the displayed logon screen, a user will typically click a ‘logon’ at step S3 to cause the input data to be transmitted from the desktop PC 2 to the server 10 which acts as a domain controller. The data is transmitted at step S4. At step S5 the server 10 acting as a domain controller determines whether or not the received username and password match a username and password combination stored within a database accessible to the server 10. If it is determined that the supplied data matches that stored in the database, the user is logged onto the network at step S6. If however step S5 determines that the provided details are incorrect, at step S7 a bad count is updated to indicate a failed login attempt for that username. A system is typically configured such that if a user enters an incorrect password on more than 3 occasions the account is locked. At step S8 a check is made to determine whether or not the limit for incorrect password entries has been reached. If this limit has been reached the user's account is locked at step S9. Otherwise, processing passes from step S8 to step S1 where the logon screen is again presented.

The logon process described above with reference to FIG. 3 will be well known to those of ordinary skill in the art. A logon process in accordance with the present invention is now described.

FIG. 4 is a schematic illustration of software components distributed between the desktop PC 2 and the server 11 to allow a user of the desktop PC 2 to logon to the network 1 using a process in accordance with the present invention. The embodiment is described in the context of a computer network running on the Microsoft™ Windows™ XP Operating system. It will however be appreciated that other embodiments may user other operating systems.

The software components associated with a desktop PC 2 comprise a graphical identification and authentication (GINA) dynamic link library (DLL) 19. In the Windows operating systems the GINA is a replaceable DLL component which is loaded by a WinLogon executable 20 to implement the authentication policy of the network. In the described embodiment the GINA DLL 19 is especially configured to implement the invention, and it is caused to be loaded by the WinLogon executable 20 by the setting of an appropriate registry key within the Windows operating system. The appropriate registry key is HKEY_LOCAL_MACHINE\Software\Microsoft NT\CurrentVersion\Winlogon, and the GINADLL value is set to contain a string indicating the path of the GINA DLL 19.

The GINA DLL 19 additionally communicates with a conventional Microsoft™ GINA DLL 21. The Microsoft™ GINA DLL is that which is loaded by the WinLogon executable 20 by default to prompt a user for username and password details as described with reference to FIG. 3.

The GINA DLL 19 additionally communicates with a core component 22 which in turn communicates with a token provider 23. The token provider 23 is a software service which allows the core 22 to obtain token details from a token which is removably connected to the desktop PC 2. In the illustrated embodiment, the token provider 23 communicates with a card reader component 24 which is configured to access data stored on a token 25 inserted into a card reader.

Additionally, the core component 22 communicates with an NT client component 26. The NT client component 26 is configured to allow communication between the desktop PC 2 and the sever 11. More particularly, the NT client component 26 is configured to allow communication with an identity store component 27 which runs on the server 11. The identity store component 27 communicates with a data repository 28. In the illustrated embodiment of the invention the data repository 28 is implemented using Novell Secret Store comprises a secret store component 29 and a secret store repository 30.

The identity store component 27 further communicates with an application log component 31 which is configured to log activity carried out by the identity store component 27. Additionally, the identity store component 27 communicates with a password filter component 32 which in turn communicates with a LSA component 33 which is part of the standard Windows security infrastructure.

FIG. 4 also illustrates an active directory service 34 which is the directory service provided by the Windows operating system, and in this case runs on the server 10 which acts as a domain controller.

It has been described above that the core component 22 communicates with a token provider 23 which is a software service configured to read data from appropriate tokens. FIG. 5 shows the core component 22 in communication with two token providers 35, 36. The token provider 35 communicates with readers 37, 38 while the token provider 36 communicates with a reader 39. The benefits of providing a plurality of token providers 35, 36 are discussed in further detail below.

An authentication method using the software components shown in FIG. 4 is now described with reference to FIGS. 6 and 7.

Referring now to FIGS. 6 and 7, a process for authenticating a user to allow a user using the desktop PC 2 to logon to the network 1 (FIG. 1) is now described. More particularly, the process is described in the context of a user using the desktop PC 2 to logon to the active directory service 34 provided by the server 10 as shown in FIG. 4. As described above, the Windows operating system automatically loads the GINA DLL 19 and it is this DLL which is responsible for the authentication process.

Referring now to FIG. 6, at step S10 a token call back function listens for events of interest. This token call back function is provided by the core component 22 and communicates with the token provider 23 to detect insertion of a token 25 into a card reader. When insertion of a token is detected at step S11, a check is made to determine (at step S11a) whether or not the token is locked (for example because of a number of previous failed attempts to use the token. If the token is locked a message is displayed (step S11b) and processing returns to step S10. If the token is not locked, the core component 22 causes the GINA DLL 19 to display an appropriate dialog prompting a user to enter a personal identification number (PIN) at step S12. This PIN is required so as to ensure that the user is a legitimate user of the token 25. A PIN is received from a user via an appropriate dialog provided by the GINA DLL 19 at step S13 and is provided to the token provider 23 at step S14. More particularly, the GINA DLL receives the PIN as input data from the dialog, passes this received data to the core component 22 and the core component processes the received data by passing the received data to the token provider 23. The token provider 23 is then charged with verifying the PIN.

In preferred embodiments of the invention verification of the PIN is accomplished by passing the received PIN to the card reader component 24 which in turn passes the PIN to the token 25. The token 25 takes the form of a smartcard. Appropriate program code is stored on the smartcard to receive the PIN and carry out verification using data stored on the token. Such verification is carried out at step S15 and will be well known to those skilled in the art from other smartcard systems. The smartcard provides output data indicating whether or not the verification at step S15 was successful. This data is passed to the card reader component 24, onwards to the token provider 23 and then onwards to the core 22. The core 22 then analysis the received input data at step S16 to determine whether or not the PIN input by the user at step S13 was correct.

If the input PIN is incorrect a bad count is incremented at step S17 and at step S18 a check is made to determine whether or not the limit for incorrect PIN entries has been reached. If this limit has been reached the token is locked at step S19. If however the limit has not been reached processing passes from step S18 to step S12.

If the input PIN is determined to be correct, at step S20 the core component 22 carries out processing to obtain a unique identifier from the token 25. This comprises passing a request to the core component 22, which in turn requests data from the token provider 23 which results in the card reader component 24 being requested to read a unique identifier from the token 25. When a unique ID is read in this way and passed to the core 22 this unique ID is then passed to the NT client component 26 at step S21. The NT client component 26 is configured for communication with a server 11. More particularly upon receipt of the unique ID, the NT client 26 attempts to locate an identity store in which authentication data associated with the obtained unique ID is stored. Such processing is carried out at step S22. Processing then passes to FIG. 7.

Having located the identity store 27 stored on the server 11, the NT client 26 and the identity store component 27 are in communication with one another. The NT client component 26 then requests authentication data from the identity store 27 using the obtained unique ID (step S23). Having received the unique ID at step S24, the identity store 27 queries the data repository 28 in an attempt to locate authentication data associated with the unique ID. This querying involves a lookup in the data repository 28. As mentioned above, the data repository 28 is, in preferred embodiments of the present invention an encrypted data store implemented using the Novell secret store product available from Novell, Inc of Waltham, Mass., USA. The Novell Secret Store product provides a convenient encrypted data repository which can be used to store authentication data and subsequently to query authentication data. It will however be appreciated that other products are equally appropriate for implementations of the present invention.

The secret store component 29 receives the request for authentication data associated with a particular unique ID at step S24 and attempts to retrieve appropriate data from the secret store repository 30 at step S25. Regardless of whether or not the attempt to retrieve data is successful, at step S23 a user object is created. This user object can suitably take the form illustrated in FIG. 8. That is the object comprises a unique ID field which stores the unique ID provided to the secret store together with authentication data in the form of a username and password stored into appropriately named fields. An authentication policy field stores appropriate authentication data. The authentication policy field stores a bit mask indicating data required for authentication. In the embodiment of the invention described above only a single authentication policy requiring input of a PIN is provided. However, alternative embodiments of the invention may use different authentication methods, for example authentication methods involving biometric information such as finger prints. A domain field stores an identity of a domain on which the username and password can be used.

If the attempt to retrieve data at step S25 is successful, the user object created at step S23 has username and password field populated with the appropriate retrieved data. If however the attempt to retrieve data at step S25 is unsuccessful the username and password fields of the user object are set to default values.

At step S27 the created user object is transmitted from the identity store component 27 directly to the GINA DLL 19 (this communication is illustrated by a broken line in FIG. 4). Upon receipt of this object, the GINA DLL 19 queries the username and password fields of the user object at step S28. This querying determines whether the username and password fields are populated or set to default values. If the user object has populated username and password fields, processing passes from step S28 to step S29 where the user is authenticated and logged onto the network using the username and password details of the received user object. More specifically, this involves the GINA DLL 19 communicating with the Microsoft™ GINA DLL 21. This is accomplished by causing the Microsoft™ GINA DLL 21 to be called to display its logon dialog. Various features of the graphical user interface, programmers interface are then used to populate the displayed dialog. Having populated the appropriate fields of the displayed dialog, an appropriate graphical user interface function can be called to cause authentication to be carried out by mimicking the clicking of a logon button provided by the dialog. Once this button press is mimicked the processing passes to step S30 where the input data is used to log the user onto the network. That is, the user is logged onto the Active Directory 34, which is located using the domain field of the received object.

If the object received is, at step S27 is determined to have a username and password field set to default values, processing then passes to step S31 where a message is displayed to the user indicating that no username and password details are associated with their token. That is, the data repository 28 does not have any associated authentication data with the unique ID read from the token. Having displayed an appropriate message at step S31, processing passes to step S32 where the GINA DLL 19 passes control to the Microsoft™ GINA DLL 21. The Microsoft™ GINA DLL 21 then displays an appropriate dialog prompting the user to enter a username and password. The user then enters this data and logs on in the usual manner.

Conventionally, the Microsoft™ GINA DLL 21 provides details of a users username and password to the WinLogon executable 20. In the illustration of FIG. 4 it can be seen that communication between the Microsoft™ GINA DLL 21 and the WinLogon executable 20 is carried out via the GINA DLL 19. Therefore, at step S33 the GINA DLL 19 is able to capture the input username and password details provided to the Microsoft™ GINA 21 as they are transmitted to the WinLogon component 20. Having captured this data the received user object is updated at step S34. That is the username and password field which are currently set to default values are updated with the username and password values input to the Microsoft™ DLL 21 by the user. Having updated the user object in this way (step S34) the updated object is transmitted to the identity store component 27 at step S35. At step S36 the identity store component 27 causes appropriate data to be stored in the data repository 28. This means that when the user's token is subsequently used, the attempt to retrieve data from the data repository 28 made at step S22 will successful and therefore the query carried out by the GINA DLL 19 at step S25 will result in populated fields being detected thus allowing the user to logon without again inputting a username and password.

Thus, it can be seen that the processing described above allows a user to be authenticated on a computer network requiring a specific username and password using a smartcard and PIN having no direct relationship to that username and password. This is achieved by storing appropriate authentication data in a data repository 28 and associating this authentication data with an ID associated with the smart card.

In some embodiments of the present invention, the user object described above with reference to FIG. 8 takes a different form. Such a user object is now described with reference to FIGS. 9 and 10.

FIG. 9 illustrates an alternative user object which again has a unique ID field but this time contains only a single further field named credentials. The credentials field can reference one or more credentials objects having the form shown in FIG. 10. Each credentials object has a GUID field, and a username field, password field, an authentication policy field and a domain field. Thus, a particular user object can have a plurality of different credentials allowing different authentication data to be stored. Thus, in a system in which different authentication data needs to be used by a single user in different circumstances, appropriate data can be stored in the data repository 28 with the GINA DLL 19 being configured to read appropriate credentials on the basis of a particular GUID value.

Referring back to FIG. 4, operation of the password filter 32 and its interaction with the identity store component 27 is now described with reference to the flowchart of FIG. 11. The password filter 32 is concerned with ensuring that when a user changes a password associated with the active directory 34, that this password change is reflected in the data repository 28. This is achieved as is now described.

At step S40 a user's password is changed using the local security authority (LSA) component 33. The LSA component 33 provided by the Windows operating system is by default configured to notify any and all registered password filters of this password change. Password filters are registered by adding their path to a string named notification packages in a registry key named HKEY_LOCAL_MACHINE\System\CurrentControlSet\Control\LSA. The path of the password filter 32 is added to the appropriate registry key and accordingly, the password filter 32 is informed of the new password.

Having received this new password information, at step S42 an attempt is made, at step S43, to locate appropriate details from the data repository 28. That is, a search is carried out to identify any records within the Secret Store repository 30 having a username matching that provided to the password filter 32 by the LSA component 33. This search is carried out by the password filter 32 passing a request to the identity store 27 which in turn requests data from the data repository 28. This results in a user object of the type described above being generated and returned to the password filter 32. If the attempt to locate data was successful an object having populated unique ID and password fields is received, otherwise these fields are set to default values. At step S44 the state of this received object is determined. More specifically, a check is made to determine whether or not the unique ID fields and password fields are populated for the provided username or set to default values. If these fields are set to default values processing passes to step S45 and then terminates. That is it can be determined that authentication data for that username is not present in the data repository 28, and no update is therefore required. If however the unique ID and password field are populated, processing passes to step S45 where the password field of the received object is updated with the data received from the LSA component 33, and the updated object is then passed to the identity store 27 and onwards to the data repository 28 for storage of step S46.

Referring again to FIG. 4, it can be seen that the identity store component 27 communicates with the NT application log component 31. The NT application log component logs activity within the identity store, more specifically data read from the identity store and data written to the identity store. Logging such activity using the NT application log 31 provides a convenient audit mechanism.

Much of the discussion set out above has been concerned with authentication processing at logon. However, in accordance with some embodiments of the present invention further processing is also carried out. Referring now to FIG. 12, there is illustrated a flowchart of such processing. Step S50 illustrates a continuous loop in which the GINA DLL ‘listens’ for events of interest. Such events typically include the insertion or removal of tokens. When such an event is detected its type is obtained and then an appropriate registry key is queried at step S51. The action indicated by this registry key is then carried out at step S52. Thus, by setting a plurality of different registry keys different actions can be carried out for different token based activities. For example removal of the token may result in the computer being locked until the user again enters their PIN number or alternatively enters their username and password. Indeed, the insert of a token following its removal would be an event detected by the loop at step S50 and the appropriate registry key would be queried to determine the action which should be taken.

Referring back to FIG. 5 the use of tokens is now described in further detail.

In the embodiment described above the token provider is concerned with reading data from a smartcard inserted into an appropriate smartcard reader. Such tokens may be compliant with the PKCS#11 standard. In FIG. 5, the token provider 36 is connected to a smartcard reader 39 and therefore functions in a manner described above. However, in the embodiment of FIG. 5 a further token provider 35 is also provided which communicates with readers 37 and 38 as described above. This token provider can be concerned with tokens other than smartcards. For example, the token provider 35 may be concerned with Bluetooth communication and each of the readers 37 and 38 may be appropriately configured for Bluetooth communication. In such embodiments of the invention the token need not take the form of a smartcard but can instead take the form of any appropriate Bluetooth enabled device. For example in some embodiments of the present invention the token may take the form of an appropriately programmed mobile telephone, the mobile telephone comprising computer program code to carry out the PIN number verification carried out by the smartcard in the embodiments of the invention described above. That is, in such embodiments of the invention a user placing their mobile phone within a predetermined distance of an appropriate reader will be prompted to enter their PIN. Assuming that this PIN number is entered correctly the users authentication data can then be obtained from the data repository 28 and used to log the user onto the system. In such embodiments an identifier associated with the phone (e.g. its IMEI number) may be used as a unique identifier or alternatively an identifier associated with a subscriber identity module (SIM) card may be used.

In still alternative embodiments of the invention, a token provider can be concerned with communication over a protocol such as the Universal Serial Bus (USB). That is, the token may take the form of a suitably programmed USB memory device storing an encrypted PIN. When the USB token is inserted into the computer the user is prompted for a PIN and suitably configured computer program code then access the encrypted PIN from the USB memory device, carry out a comparison and assuming that this comparison is met allow the user to access the system in the manner described above.

Additionally, it will be appreciated that although most smartcards are read by readers having contacts which directly contact the smartcard, contactless smartcards are also available and such smartcards are equally applicable to the present invention.

The present invention can also be used to implement a cached login. That is, authentication as described above can be provided when a network connection is not available. This is achieved by downloading to one of the computers (for example the laptop computer 5) data required to carry out authentication when the laptop computer 5 is connected to the network 1. Thereafter, even when the laptop computer 5 is not connected to the network 1, authentication as described above can be carried out. Such authentication can ensure that an input PIN number matches a particular token and subsequently can allow retrieved data to be used as a basis for authentication.

When a particular token is removed from a token reader the system can be configured such that if another users token is connected to the token reader the previous user is logged off (perhaps with critical data being stored) and the new user is logged on.

The embodiments of the invention described above have been implemented in a system suitable for use with a Windows 2000, Windows XP and Windows 2003 Server operating systems provided by Microsoft coporation. The implemented embodiments were written in the Visual C++ programming language.

Although preferred embodiments of the invention have been described above, it will be appreciated that various modifications can be made to these embodiments without departing from the spirit and scope of the present invention. In particular, it will be appreciated that the invention can be applied to network topologies different from that shown in FIG. 1. Furthermore, in the illustration of FIG. 4 it will be appreciated that the illustrated software components can be distributed between the client and the server in different ways from that illustrated.

1. A computer-implemented method of authenticating a user, comprising:
reading an identifier from a token, said token being in communication with said computer;
attempting to locate a record in a data store on the basis of said identifier, said record comprising authentication data; and
if said attempting is successful, performing authentication using said located authentication data.

2. A method according to claim 1, wherein said authentication data comprises first and second data items.

3. A method according to claim 2, wherein said first data item is a username, and said second data item is a password.

4. A method according to claim 2, wherein records of said data store store an identifier together with respective first and second data items.

5. A method according to claim 1, wherein said authentication data comprises data indicative of an authentication policy.

6. A method according to claim 1, further comprising:
if said attempting is unsuccessful, requesting input data comprising authentication data;
receiving input data comprising said authentication data; and
performing authentication using said authentication data of said input data.

7. A method according to claim 6, further comprising:
if said attempting is unsuccessful, creating a record in said data store associating said identifier with said input authentication data.

8. A method according to claim 6, wherein said input authentication data comprises first and second input data items.

9. A method according to claim 8, wherein said first input data item is a username and said second input data item is a password.

10. A method according to claim 1, further comprising:
if said attempting is successful, receiving an object, said object comprising said identifier, and at least one field storing said authentication data.

11. A method according to claim 10, further comprising:
if said attempting is unsuccessful, receiving an object comprising said identifier, and at least one field storing a default value.

12. A method according to claim 10, wherein said received object comprises first and second fields, said first and second fields storing said authentication data if said attempting is successful and said first and second fields storing default values if said attempting is unsuccessful.

13. A method according to claim 10, wherein said received object comprises a third field, said third field storing data indicative of an authentication policy.

14. A method according to claim 11, wherein determining whether said attempting is successful comprises:
querying said at least one field.

15. A method according to claim 11, wherein:
said attempting is determined to be unsuccessful if said at least one field stores a default value; and
said attempting is determined to be successful if said at least one field stores populated with authentication data.

16. A method according to claim 10, wherein said received object comprises a plurality of sets of authentication data.

17. A method according to claim 16, further comprising selecting one of said plurality of sets of authentication data, and performing authentication using said selected authentication data.

18. A method according to claim 1, wherein reading an identifier from said token comprises:
reading an identifier from said token;
prompting a user to input a verification data item associated with said token; and
verifying said verification data item associated with said token.

19. A method according to claim 18, wherein said verification is carried out by said token.

20. A method according to claim 18, wherein verifying said data item comprises:
providing said verification data item to said token together with a request for verification; and
receiving data indicating whether said verification was successful from said token.

21. A method according to claim 18, wherein said verification data item is a personal identification number.

22. A method according to claim 1, wherein said authentication using said authentication data is carried out by an authentication service provided by an operating system.

23. A method according to claim 22, further comprising:
prompting the operating system to display a dialog; and
providing said authentication data via said dialog.

24. A method according to claim 1 further comprising storing data recording data read from and data written to said data store.

25. A method according to claim 1 wherein said data store is an encrypted data store.

26. A method according to claim 1, comprising:
receiving data indicative of a change to said authentication data; and
updating said data store in response to said change.

27. A method according to claim 26, wherein said change to said authentication data comprises a change to said authentication data in an operating system data store.

28. A method according to claim 26, wherein said authentication data comprises a password and said change to said authentication data comprises a change to said password.

29. A method according to claim 1 wherein said token is a smartcard.

30. A method according to claim 29, wherein said smartcard is a contact or contactless smartcard.

31. A method according to claim 1, wherein communication between said token and said computer is wireless communication.

32. A method according to claim 31, wherein said communication is Bluetooth communication.

33. A data carrier carrying computer readable instructions configured such that when the computer readable instructions are executed, they cause a computer to:
read an identifier from a token, said token being in communication with said computer;
attempt to locate a record in a data store on the basis of said identifier, said record comprising authentication data; and
if said attempt is successful, perform authentication using said located authentication data.

34. A computer apparatus for authenticating a user, the computer apparatus comprising:
a program memory containing processor readable instructions; and
a processor configured to read and execute instructions stored in said program memory;
wherein said processor readable instructions comprise instructions controlling the computer to:
read an identifier from a token, said token being in communication with said computer;
attempt to locate a record in a data store on the basis of said identifier, said record comprising authentication data; and
if said attempt is successful, perform authentication using said located authentication data.

35. A computer implemented method of authenticating a user, comprising:
reading an identifier from a token, said token being in communication with said computer;
requesting authentication data from a remote data store on the basis of said identifier; and
if said requesting returns authentication data, performing authentication using said authentication data.

36. A method according to claim 35, wherein said authentication data comprises first and second data items.

37. A method according to claim 36, wherein said first data item is a username, and said second data item is a password.

38. A method according to claim 35, wherein said authentication data comprises data indicative of an authentication policy.

39. A method according claims 35, further comprising:
if said request does not return authentication data, requesting input data comprising authentication data;
receiving input data comprising said authentication data; and
performing authentication using authentication data of said input data.

40. A method according to claim 35, wherein reading an identifier from said token comprises:
reading an identifier from said token;
prompting a user to input a verification data item associated with said token; and
verifying said verification data item associated with said token.

41. A method according to claim 40, wherein said verification is carried out by said token.

42. A method according to claim 40, wherein verifying said data item comprises:
providing said verification data item to said token together with a request for verification; and
receiving data indicating whether said verification was successful from said token.

43. A method according to claim 40, wherein said verification data item is a personal identification number.

44. A method according to claim 35, wherein said token is a smartcard.

45. A data carrier carrying computer readable instructions, the computer readable instructions configured such that when executed cause a computer to:
read an identifier from a token, said token being in communication with said computer;
request authentication data from a remote data store on the basis of said identifier; and
if said requesting returns authentication data, perform authentication using said authentication data.

46. A computer apparatus for authenticating a user, the computer apparatus comprising:
a program memory containing processor readable instructions; and
a processor configured to read and execute instructions stored in said program memory;
wherein said processor readable instructions comprise instructions controlling the computer to:
read an identifier from a token, said token being in communication with said computer;
request authentication data from a remote data store on the basis of said identifier; and
if said requesting returns authentication data, perform authentication using said authentication data.

47. A computer implemented method for authenticating a user, comprising:
receiving an identifier from a remote computer, said identifier being read from a token which is in communication with said remote computer;
attempting to locate a record in a data store on the basis of said received identifier, said record comprising authentication data; and
transmitting data to said remote computer and indicating whether said attempting is successful;
wherein if said attempting is successful, said remote computer performs authentication using said located authentication data.

48. A method according to claim 47, wherein said authentication data comprises first and second data items.

49. A method according to claim 48, wherein said first data item is a username, and said second data item is a password.

50. A method according to claim 47, wherein said authentication data comprises data indicative of an authentication policy.

51. A method according to claims 47, wherein if said attempting is unsuccessful the method further comprises:
receiving authentication data from said remote computer; and
creating a record in said data store associating said identifier with said received authentication data.

52. A method according to claim 47, further comprising:
if said attempting is successful, transmitting an object to said remote computer, said object comprising said identifier, and at least one field storing said authentication data.

53. A method according to claim 52, further comprising:
if said attempting is unsuccessful, transmitting an object comprising said identifier, and at least one field storing a default value.

54. A method according to claim 52, wherein said transmitted object comprises first and second fields, said first and second fields storing said authentication data if said attempting is successful and said first and second fields storing default values if said attempting is unsuccessful.

55. A method according to claim 52, wherein said transmitted object comprises a third field, said third field storing data indicative of an authentication policy.

56. A networked computer system comprising a terminal in communication with a server, wherein:
the terminal comprises means for reading an identifier from a token in communication with the terminal; and means for transmitting said identifier to said server;
the server comprises means for receiving a transmitted identifier, means for attempting to locate a record in a data store on the basis of said identifier and means for transmitting data to said at least one terminal indicating whether said attempting is successful; and
the terminal comprises means for performing authentication using data located by said server.

57. A system according to claim 56, wherein said means for performing authentication is configured to transmit authentication data to a domain controller.

58. A system according to claim 57, wherein said domain controller is said server.
